(19) United States
(12) Patent Application Publication
(10) Pub. No.: US 2003/0233253 A1
(43) Pub. Date: Dec. 18, 2003

(54) Point-of-care clinical documentation software system and associated methods

(76) Inventors: Thomas C. Peth, Lancaster, PA (US); Timothy C. Peth, Mohrsville, PA (US)

Correspondence Address: Reed Smith Shaw & McClay, LLP, 213 Market Street/ 9th Floor, P.O. Box 11844, Harrisburg, PA, 17108-1844, US

(21) Appl. No.: 10/426,667

(22) Filed: Apr. 30, 2003

Related U.S. Application Data
(60) Provisional application No. 60/376,660, filed on Apr. 30, 2002.

(51) Int. Cl. G06F 17/60

(52) U.S. Cl. 705/2; 705/3

(57) ABSTRACT

The present invention enables the creation of a structured, outcomes-based problem-specific patient care plan that is automatically updated every visit. As clinicians perform initial and ongoing assessments, NDoc continuously applies rules-based logic to identify new patient problems and determine which existing problems have been resolved. Interventions and outcomes relating to active problems are highlighted dynamically, drawing clinicians' attention to current patient issues while at the same time providing a complete clinical charting environment for comprehensive documentation. A multi-session software system is also disclosed, which allows users to concurrently perform several disparate tasks without having to complete and close one process before starting another.

### CROSS-REFERENCE TO RELATED APPLICATIONS

This application claims the benefit under 35 U.S.C. § 119(e) of the earlier filing date of U.S. Provisional Patent Application Serial No. 60/376,660 filed on Apr. 30, 2002.

### STATEMENT REGARDING FEDERALLY SPONSORED RESEARCH OR DEVELOPMENT

Not Applicable

### REFERENCE TO A “MICROFICHE APPENDIX”

Not Applicable

### BACKGROUND OF THE INVENTION

1. Field of the Invention

The present invention relates to a software system and associated methods for providing point-of-care clinical treatment, such as in the home health care environment. The present invention also relates to a multi-session software system and associated methods, which allow users to concurrently perform several disparate tasks without having to complete and close one process before starting another.

2. Description of the Related Art

The Outcome and ASessment Information Set (OASIS) is a group of data elements that represent core items of a comprehensive assessment for an adult home care patient; and form the basis for measuring patient outcomes for purposes of outcome-based quality improvement (OBQI). The OASIS—a component of Medicare's partnership with the home care industry to foster and monitor improved home health care outcomes—is proposed to be an integral part of the revised Conditions of Participation for Medicare-certified home health agencies (HHAs).

Most data items in the OASIS were derived in the context of a national research program funded by the Health Care Financing Administration (HCFA) (now known as the Centers for Medicare & Medicaid Services or “CMS”), the purpose of which was to develop a system of outcome measures for home health care. This program, and the OASIS, have evolved over a ten-year developmental period. The core data items were refined through several iterations of clinical and empirical research. Other items were added later by a work group of home care experts to augment the outcome data set with selected items deemed essential for patient assessment. The goal was not to produce a comprehensive assessment instrument, but to provide a set of data items necessary for measuring patient outcomes and essential for assessment—which HHAs in turn could augment as they judge necessary. Overall, the OASIS items have utility for outcome monitoring, clinical assessment, care planning, and other internal agency-level applications.

HCFA has finalized two rules relating to HHAs. One rule revises the existing HHA Conditions of Participation by requiring that HHAs collect OASIS data. The other expands those new Conditions of Participation by requiring HHAs to report OASIS data to their State survey agency.

HHAs are required to electronically transmit OASIS data to the standard State system, which has been installed by HCFA. The State agencies have the overall responsibility for collecting OASIS data in accordance with HCFA specifications. The State is also responsible for preparing OASIS data for retrieval by a central repository to be established by HCFA.

In situations where coverage of the provider's services is through Medicare, a patient's physician must complete and sign a form (The Home Health Certification and Plan of Care, or “HCFA 485”) within 30 days of the start of care. This incorporates initial orders and clinical assessment, and is required to meet regulatory requirements and for reimbursement. It requires the physician orders to specify the amount, frequency, and duration for disciplines and treatments.

OASIS data items encompass sociodemographic, environmental, support system, health status and functional status attributes of adult (nonmaternity) patients. In addition, selected attributes of health service utilization are included. These several different types of attributes should be part of a comprehensive patient assessment. However, as HCFA itself emphasizes, OASIS was not developed as a comprehensive assessment tool.

In addition to measuring patient outcomes, OASIS data have uses in the areas of: patient assessment and care planning for individual adult patients; agency-level case mix reports that contain aggregate statistics on various patient characteristics such as demographic, health, or functional status at start of care; and internal HHA performance improvement.

Because most OASIS items describe patient health and functional status, they are useful in assessing the care needs of adult patients. However, it is necessary for HHAs to supplement the OASIS items in order to comprehensively assess the health status and care needs of their patients. For example, the OASIS does not include vital signs, which are typically included in patient assessments.

Other home care systems available today, if they do suggest treatment protocols, will not do so until after a complete assessment of the patient is performed. They then require the clinician to manually adapt a standard care plan to meet the specific needs of a patient. Others require that the clinician build a care plan from the ground up. That is, after the OASIS items and, usually, other aspects of the patient's condition are assessed and recorded for a particular patient, that patient is typically assigned to a standard care plan (or clinical pathway) representative of the primary reason for home care. In some settings, where HHA policy/procedure does not include the use of pathways or standards of care, the clinician develops a care plan from scratch. The danger of these approaches lies in the tendency to ignore ancillary conditions in an ongoing treatment plan by accidentally failing to properly append to the care plan or pathway those interventions and outcomes relating to the ancillary condition(s). Another major drawback is the potential for developing a faulty care plan by accidentally choosing improper interventions/outcomes to append.

Competitive approaches to mechanize care plan development—and, specifically, attempts to develop an automated problem list—fail to recognize the importance of non-OASIS parameters, using only the OASIS elements to project the existence of a problem.

In view of the foregoing, a need has thus been recognized for a body-system driven approach, not one driven by OASIS, which will result in a comprehensive problem list and care plan. In connection with improving patient care in the home health setting, a need exists for a system which enables the development of an automated, customized plan of care, while at the same time maintaining compliance.

It is also the case that today, users of the Internet desire the ability to run multiple simultaneous interactive browser sessions. As such, a need has been recognized in connection with the development of a software system and method that—via a single log-in procedure which invokes a menuing session—allows access to any of multiple functionally-organized sub-applications, each running in its own persistent (state-aware), full-screen browser window.

### BRIEF SUMMARY OF THE INVENTION

In accordance with the present invention, a software package or point-of-care clinical documentation system is provided which—via the continuous application of a propriety rules-based logic scheme—facilitates the automatic creation and maintenance of a complete, outcome-based problem-specific patient care plan without clinician intervention. The system and method of the present invention provides the clinician with immediate feedback on which treatment/instruction is appropriate to perform during the start-of-care visit.

The present invention provides a comprehensive point-of-care system for the home health care industry, by combining powerful, yet flexible, clinician-oriented point of care technology with unique features required by home care agencies. The present invention includes real-time OASIS editing to accurately and automatically group patients into the proper home health resource group (HHRG) at the bedside, and a structured, automated rules-based problem list to help agencies deliver cost-effective patient outcomes under the prospective payment system (PPS) and managed care.

The enhanced assessment provided for pursuant to the system and method of the present invention is also useful in care planning, since it facilitates identifying areas where patient status differs from optimal health or functional status. As more precise assessments lead to improved care planning, they in turn facilitate better care because clinicians can more effectively focus on improving or maintaining current (precisely measured) health status.

The numerous benefits of the approach provided for by the present invention are clear, including but not limited to the following:

It frees the clinician from the time-consuming task of building an appropriate care plan for each patient;

It saves clinicians time throughout the episode by automating the maintenance of the care plan—as interventions are performed and outcomes are met, problems are automatically resolved and the care plan automatically updated;

It ensures consistency in an agency's care delivery model, since the system and method of the present invention will guide each clinician to deliver the same care to each patient with any specific condition or combination of conditions;

It provides structure and consistency to the electronic medical record, making it easier for physicians, auditors and surveyors to understand and utilize;

It helps ensure clinical record consistency by creating a HCFA 485 that matches the patient's care plan; and

It enables an outcomes-based approach to monitoring and marketing the cost-effective delivery of quality care, without the difficulties of maintaining a clinical pathway for each patient.

### BRIEF DESCRIPTION OF THE SEVERAL VIEWS OF THE DRAWINGS

The various features of the present invention and its presently preferred embodiments will now be described in greater detail with reference to the drawings of a preferred software package referred to as the NDoc® point-of-care system (“NDoc”), its screen displays, and various related components.

FIG. 1 is a block diagram which illustrates the general architecture of NDoc.

FIG. 2 is a screen display which illustrates the menu, tool and filter bars of the NDoc graphical user interface.

FIG. 3 is a screen display which illustrates the general layout of NDoc.

FIG. 4 is a screen display which illustrates a feature that allows a user to access key components of the patient's record from every screen within NDoc.

FIG. 5 is a screen display which illustrates a feature that allows a user to view a patient's demographic information.

FIG. 6 is a screen display which illustrates a feature that allows the display of all identified “problems” for a patient.

FIG. 7 is a screen display which illustrates a feature that allows a user to view any and all notes and other information charted on previous visits for a particular patient.

FIG. 8 is a screen display which illustrates a feature that allows a user to view all documents associated with a particular patient (such as 485's, verbal orders and OASIS assessments) and each document's current status.

FIG. 9 is a screen display which illustrates a feature that allows a user to view detailed visit records for a particular patient.

FIG. 10 is a screen display which illustrates a feature that allows a user to view remaining authorized visits for a particular patient.

FIG. 11 is a screen display which illustrates a sample Patient PROBLEMS List.

FIG. 12 is a screen display which illustrates a decision process used by NDoc to integrate Outcomes with each problem, and automatically require that such Outcomes be charted once a problem has been defined.

FIG. 13 is a screen display which illustrates the printing of pre-defined interventions on the HCFA 485 once the problem has been defined.

FIG. 14 is a screen display which illustrates the printing of pre-defined short- and long-term goals on the HCFA 485 once the problem has been defined.

FIG. 15 illustrates an exemplary Patient Problems Logic of a preferred embodiment of the present invention.

The screen displays included in the figures were generated from screen captures taken during the execution of the NDoc code. All copyrights in these screen displays are hereby reserved.

### DETAILED DESCRIPTION OF THE INVENTION

I. Glossary of Terms and Acronyms

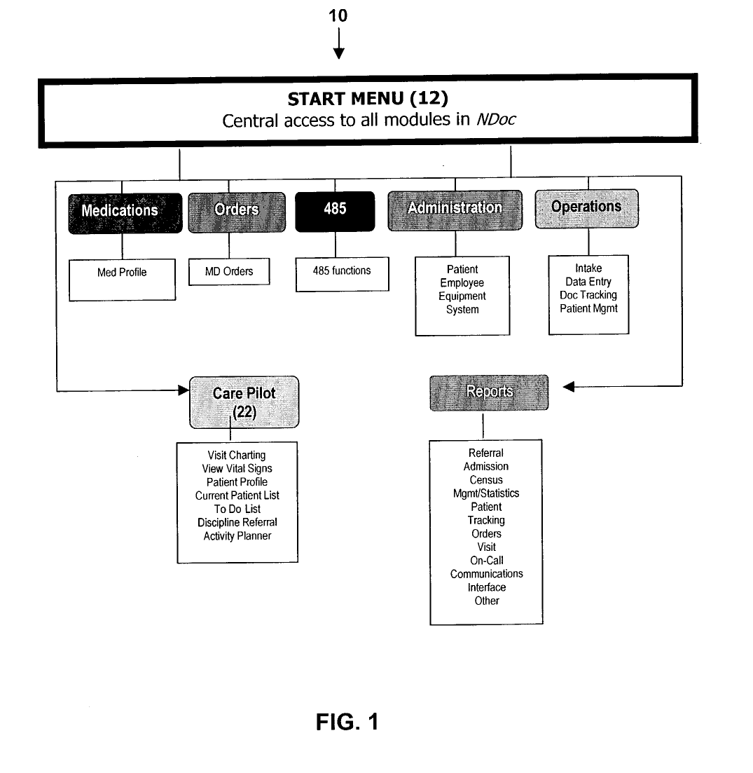

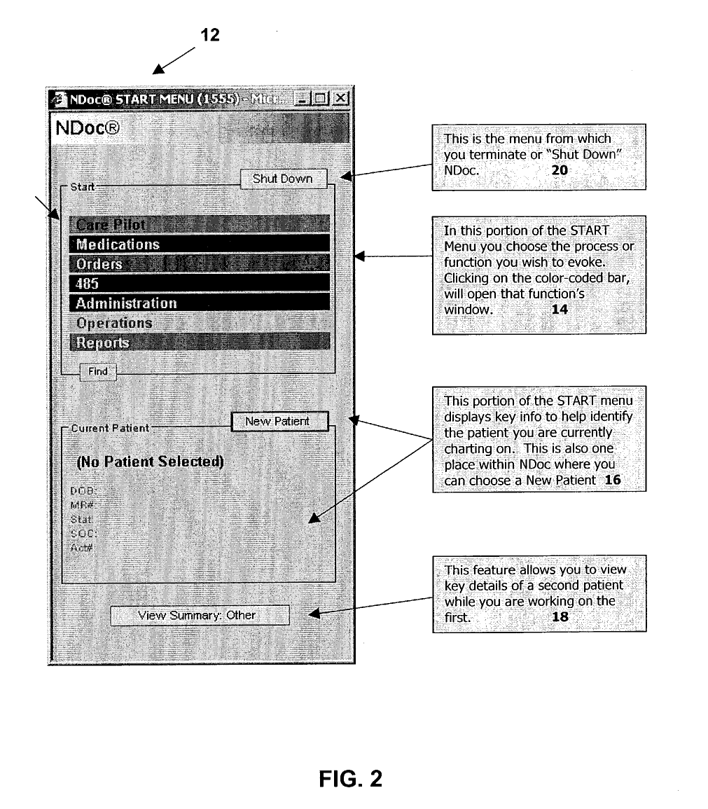

Throughout the instant disclosure, it will be appreciated that several terms may be used interchangeably with one another, some of which are briefly discussed immediately below. Reference is first made to FIG. 1, which schematically depicts a visual representation of the NDoc system module design. Various aspects of the system shown in FIG. 1 will be further appreciated from the discussion of FIGS. 2-14 provided further below, along with reference to those Figures.

The following definitions and explanations provide background information pertaining to the technical field of the present invention, and are intended to facilitate an understanding of both the invention and the preferred embodiments thereof. Additional definitions are provided throughout the detailed description.

Internet. The Internet is a collection of interconnected public and private computer networks that are linked together by a set of standard protocols (such as TCP/IP, HTTP, FTP and Gopher) to form a global, distributed network.

Hyperlink. A navigational link from one document to another, or from one portion (or component) of a document to another. Typically, a hyperlink is displayed as a highlighted word or phrase that can be clicked on using the mouse to jump to the associated document or document portion.

World Wide Web. A distributed, global hypertext system, based on a set of standard protocols and conventions (such as HTTP and HTML, discussed below), which uses the Internet as a transport mechanism. A software program which allows users to request and view World Wide Web (“Web”) documents is commonly referred to as a “Web browser,” and a program which responds to such requests by returning (“serving”) Web documents is commonly referred to as a “Web server.”

TCP/IP (Transfer Control Protocol/Internet Protocol). A standard Internet protocol which specifies how computers exchange data over the Internet. TCP/IP is the lowest level data transfer protocol of the standard Internet protocols.

II. Overview

NDoc, a full-bodied clinical documentation system, is a web-enabled program developed to run both on desktop computers and laptop, notebook or sub-notebook computers. Because it is table-based, customization and maintenance are easy to do and do not require a programming background. FIG. 1 shows a visual representation of the NDoc system module design.

In the preferred embodiment, the program runs under the Windows® operating system, and utilizes the standard protocols and conventions of the World Wide Web (“Web”)-based multi-session web application. A multi-session web application is utilized to allow users to interact with the point-of-care clinical documentation system via the Internet Explorer web browser, either on an office intranet or on their own point-of-care device.

III. NDoc START Menu and Screen Layout

The present invention includes numerous features designed to make it easy to use, including:

functions displayed on the START menu are divided into modules that mirror agency processes;

modules may be color-coded for easy “you are here” identification within the system;

navigation is straightforward—system surfing is comfortable after learning only a few basic rules; and

screens are consistent in appearance to limit confusion during transition.

When a user logs onto NDoc using his or her unique name and personal identification number (PIN), the NDoc START Menu 12 is displayed. See FIG. 2. This can be thought of as “home base.” From here, the user can choose one or multiple modules 14 to perform documenting functions, view key elements 16 of the patient currently being worked on, choose a new patient and even view key details 18 of a second patient while charting on the first. This is also where the user comes to exit, or “Shut Down” 20 NDoc.

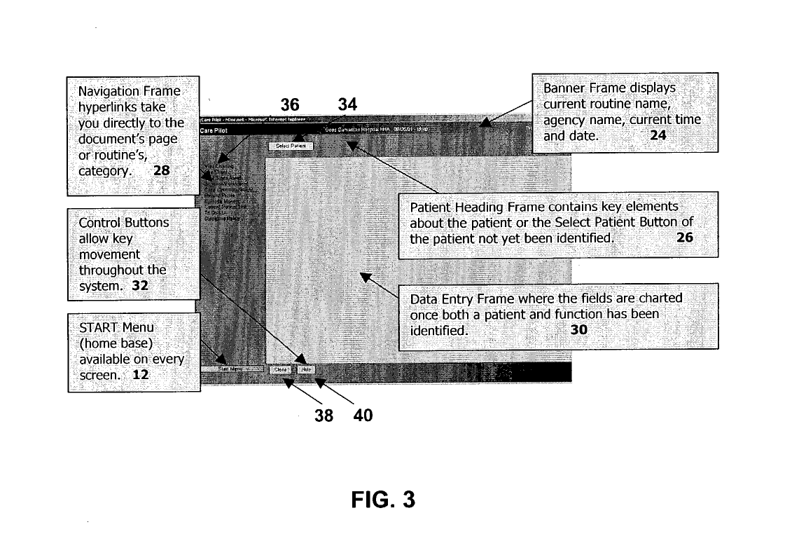

FIG. 2 shows the general layout of NDoc. Clicking the “Care Pilot” bar 22 in the START menu evokes the screen shown in FIG. 3. NDoc's Care Pilot charting module has built-in intelligence that helps reduce clinical record inconsistencies, like those between the 485 and OASIS. Further, with its multi-session design, a clinician can update meds or orders, or even view another patient's chart, without leaving Care Pilot's comprehensive assessment.

In a preferred embodiment, each NDoc screen uses the same layout containing the following frames: (i) Banner Frame 24; (ii) Patient Heading Frame 26; (iii) Navigation Frame 28; (iv) Data Entry Frame 30; and (v) Control Button Frame 32.

As FIG. 3 depicts, the Banner Frame 24 appears across the top of the screen. It identifies the routine evoked (in the case of FIG. 3, it is the NDoc Care Pilot), the user's agency name and the current time and date. The user checks to be sure they are accurate, as once he or she starts charting, dates and times are automatically attached to the charting based on the system clock.

Continuing with the screen shot depicted in FIG. 3, the Patient Heading Frame 26 appears beneath the Banner Frame. In FIG. 3, the “Select Patient” button 34 is displayed, signifying that a patient on whom the user wishes to chart has not yet been identified. Once a patient is selected, key information will appear in this frame throughout NDoc's modules.

Still referring to FIG. 3, the Navigation Frame 28 is the column on the left and is comprised of a list of hyperlinks 36. Clicking these hyperlinks takes the user directly from one screen to another without paging through the entire document or routine.

The Data Entry Frame 30 is the area to the right of the Navigation Frame 28 in FIG. 3. It is in this area that the actual charting takes place. Once a patient is selected and a function is chosen, the appropriate page displaying the fields to complete appears in this frame.

The Control Button Frame 32 appears across the bottom of the screen in FIG. 3. These buttons allow key movement throughout the system, including: (1) Close Button 38, which allows the user to close the current window; (2) Help Button 40, which displays context-specific help, i.e., help for a particular screen or field; and (3) START Menu Button 12 (home base), which is accessible from every screen. A few of the additional Control Buttons that may also appear when relevant are “Previous,” “Next,” “Cancel” and “Save.”

IV. Patient Summary

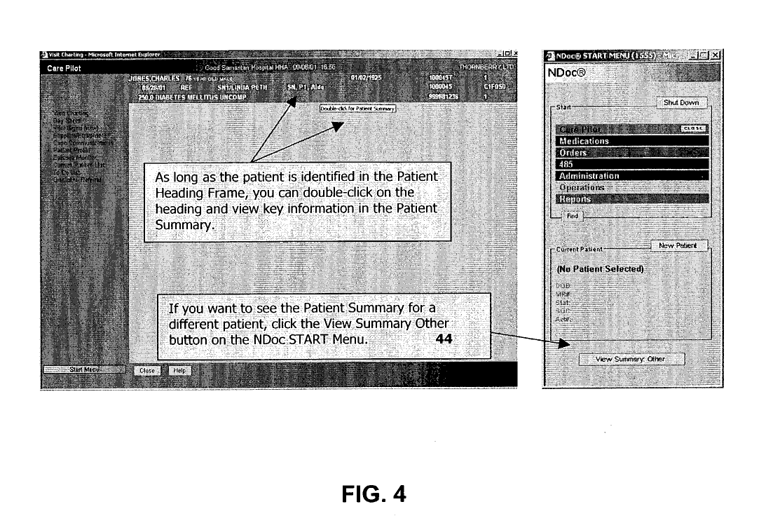

The Patient Summary 42 is NDoc's unique way to access key components of the patient's record from every screen within NDoc. If the patient is already identified, double-clicking anywhere in the Patient Heading Frame 26 displays key information in the Patient Summary 42. See FIG. 4. If the user is charting on a different patient, clicking the “View Summary Other” button 44 on the NDoc START Menu 12 allows the user to select the patient in order to view his/her Patient Summary 42.

The new NDoc multi-session design enables each user to run multiple simultaneous interactive browser sessions. A single login procedure invokes a menuing session, which in turn allows access to any of seven functionally-organized sub-applications, each pertaining to a section of a single patient electronic medical record running in its own persistent (state-aware), full-screen browser window. This multi-session architecture allows users to concurrently perform several disparate tasks without having to complete and “close” one process before starting another, and can permit read-only access to yet another patient electronic medical record without closing any of the processes open to the electronic medical record first accessed. To the clinician, this means charting in various sections of a patient medical record in a convenient manner consistent with his/her style of charting. To the information systems technician, this means deploying a TCP/IP-based web application that offers end users the flexibility and ease-of-use of a multitasking Local Area Network-based Windows(g application.

A unique device identifier is assigned at login. This identification—in conjunction with individual session identifiers—are managed by server processes to coordinate and control inter-session communication. Server-side logic and client-side scripting provide a full-featured browser interface with field-by-field data validation within each individual session, and real-time updating of relevant data between sessions.

Once the Patient Summary 42 is invoked, the default view is of key Demographics 46. Each summary window contains the Patient Heading information for easy identification. Other buttons appear along the top of the display. These allow the user to see different portions of the patient's record—right from the Patient Summary 42 function. Once the user has reviewed the needed information, he or she can either choose a different view by clicking one of the buttons across the top of the window or close the window by clicking the “Close” button 48. Were the user to click on the “Visits” button 50, for example, the “Visits” page would have a “Demographics” button to allow the user to go back to the Demographics display.

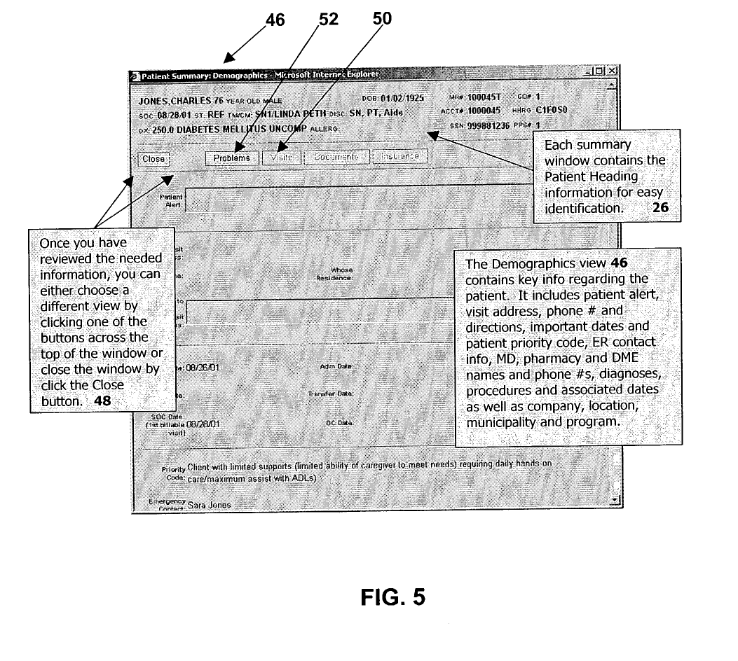

As shown in FIG. 5, the Demographics button displays the following information:

Patient Alert;

Visit Address and Directions to Visit Address;

Visit Phone and Whose Residence;

Key Dates: Referral, SOC, ROC, Transfer and DC;

Priority Code;

ER Contact with Home and Work Phone Numbers;

Attending MD Name and Phone;

Pharmacy Name and Phone;

DME Provider Name and Phone;

Diagnoses and Procedures;

Company and Location;

Municipality; and

Program.

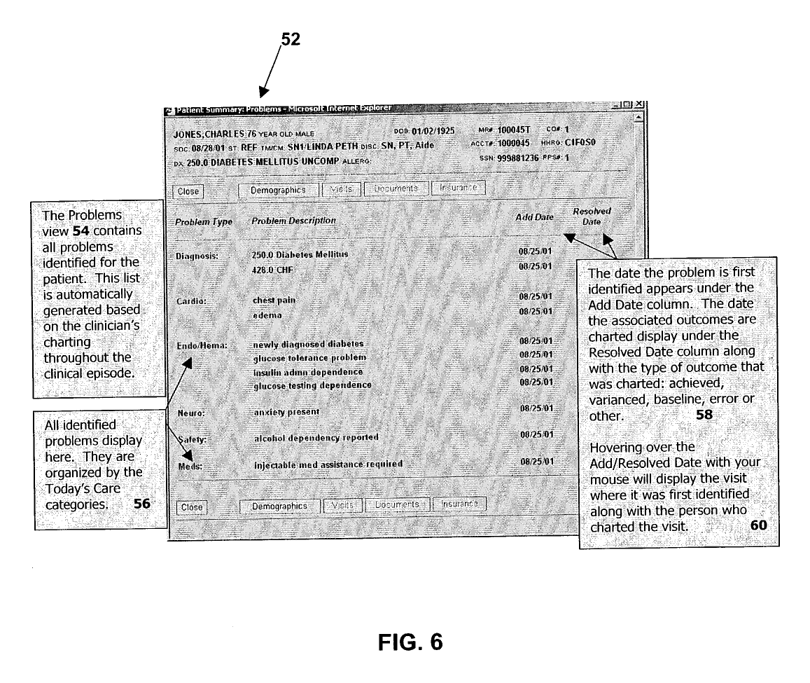

As shown in FIG. 5, buttons appear at the top of the display. These buttons allow the user to view details of importance in other areas of the patient record. For example, clicking “Problems” 52 would allow the user to view a current list of the Patient Problems 54. See FIG. 6.

The “Problems” 52 view contains all problems identified for the patient. This list is automatically generated based on the clinician's charting throughout the clinical episode. It is here that all identified problems are displayed (organized by the “Today's Care” categories 56). The date the problem is first identified appears under the “Add Date” column 58. The date the associated outcomes are charted displays under the “Resolved Date” column, along with the type of outcome that was charted (achieved, varianced, baseline, error or other). Hovering over the “Add/Resolved Date” with the mouse displays the visit where the problem was first identified, along with the person who charted the visit 60.

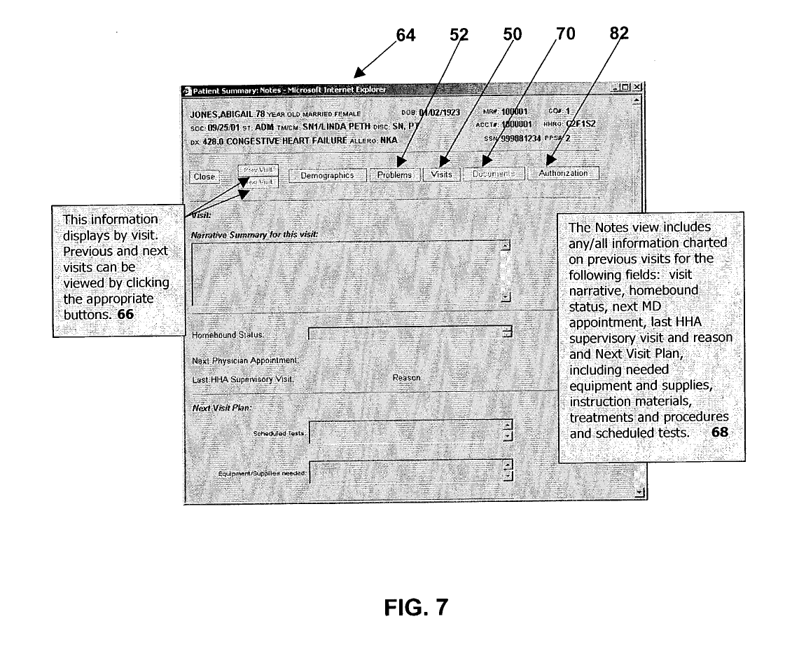

Similarly, clicking the “Notes” button 62 allows the user to view the Visit Notes 64 for the patient. See FIG. 7. This information displays by visit. Previous and next visits can be viewed by clicking the appropriate buttons 66. The “Notes” view 64 includes any and all information charted on previous visits for the following fields 68: visit narrative; homebound status; next MD appointment; last HHA supervisory visit and reason and Next Visit Plan, including needed equipment and supplies, instruction materials, treatments and procedures, and scheduled tests.

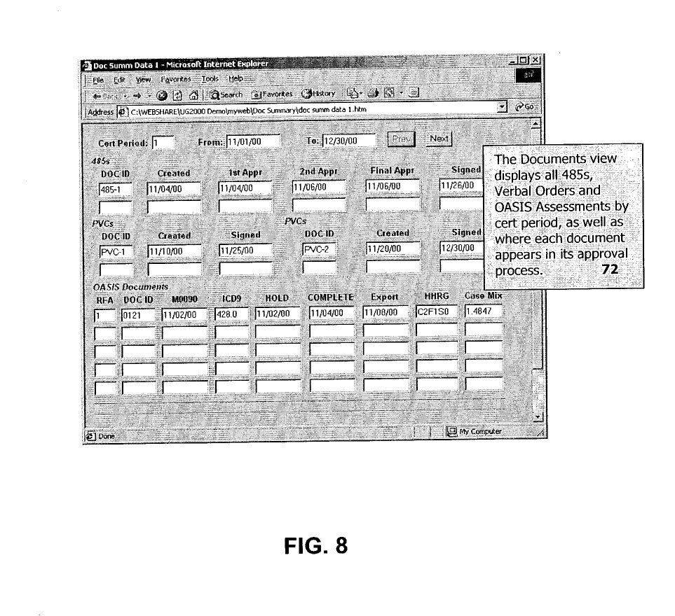

Clicking “Documents” 70 allows the user to view all the documents for the patient, along with their current status. See FIG. 8. The “Documents” view 72 displays all 485's, Verbal Orders and OASIS Assessments by cert period, as well as where each document appears in its approval process.

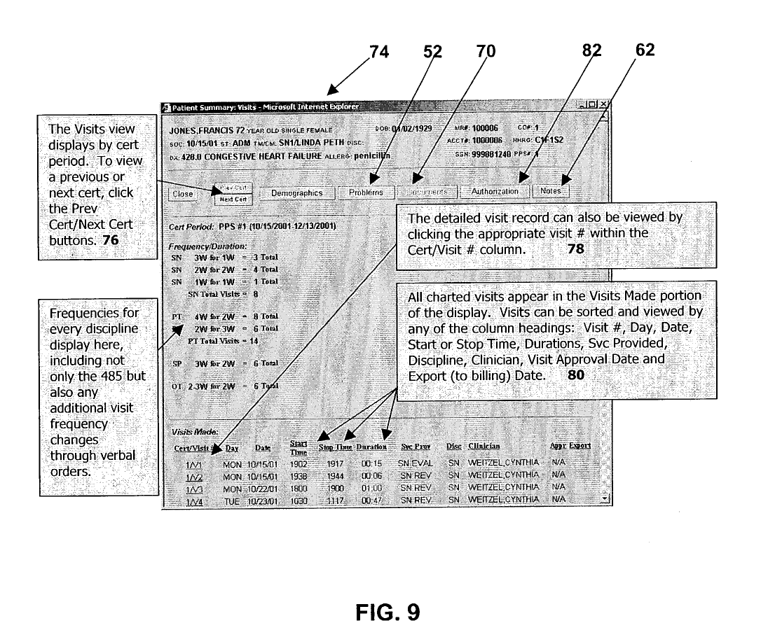

Clicking the “Visits” 50 button allows the user to see all visits that have been made, as well as the “total” frequency for each discipline—including changes due to verbal orders as well as those that appear on the 485. See FIG. 9. The “Visits” view 74 displays by cert period. To view a previous or next cert, the user clicks the “Prev Cert/Next Cert” buttons 76. The detailed visit record can also be viewed by clicking the appropriate visit # within the Cert/Visit # column 78. All charted visits appear in the “Visits Made” portion of the display 80. Visits can be sorted and viewed by any of the column headings: Visit Number; Day; Date; Start or Stop Time; Durations; Service(s) Provided; Discipline; Clinician; Visit Approval Date and Export (to billing) Date.

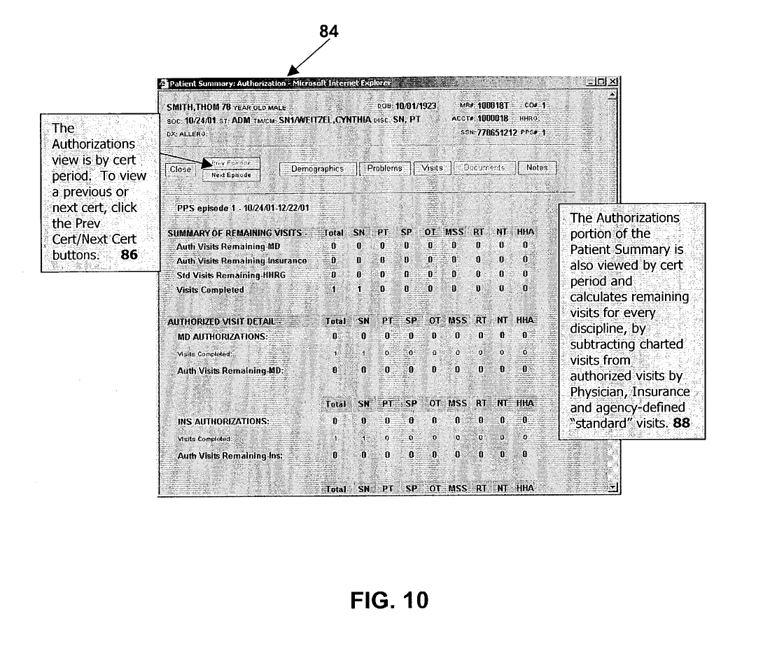

Clicking “Authorization” 82 allows the user to see remaining “authorized” visits for each discipline. See FIG. 10. The “Authorization” view 84 is by cert period. To view a previous or next cert, the user clicks the “Prev Cert/Next Cert” buttons 86.

The “Authorization” portion 88 of the Patient Summary calculates remaining visits for every discipline, by subtracting charted visits from authorized visits by Physician, Insurance and agency-defined “standard” visits.

V. Patient Problems Logic

Broadly contemplated herein, in accordance with at least one preferred embodiment of the present invention, is a point-of-care clinical documentation system which applies proprietary rules-based logic (referred to as “Patient Problems Logic”). The Patient Problems Logic 90, in conjunction with the systems and methods of the present invention, provides for a complete, outcome-based patient care plan that is not only problem-specific but also capable of being created and maintained without clinician intervention. In that manner, the Patient Problems Logic of the present invention permits a totally customized approach to a patient's plan of care.

NDoc analyzes clinicians' charting from the Start-of-Care or “SOC” visit (the date marking the beginning of the patient's home care episode, which typically is the date of the first visit by a registered nurse) throughout the clinical episode, and creates a customized plan of care that is updated with every visit. This enables the best patient care to be provided, while maintaining compliance.

Based on the clinicians' natural charting flow, Patient Problems Logic 90 can best be described in this 3-step process:

First, the clinician charts the OASIS SOC Assessment during the initial visit within NDoc's Care Pilot Module.

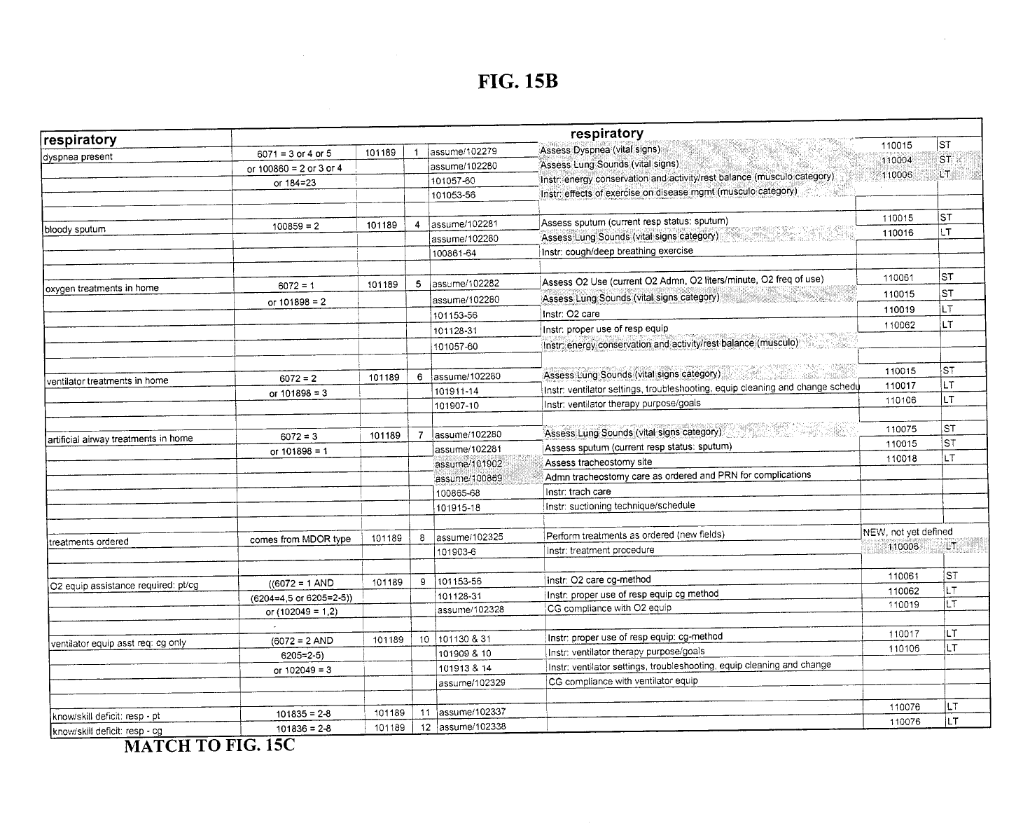

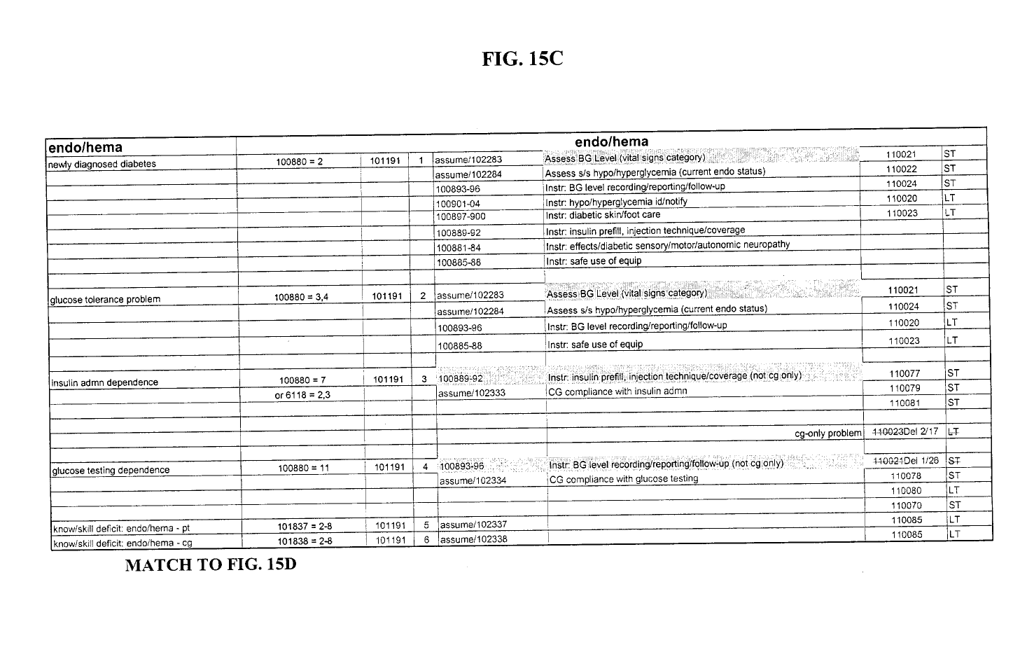

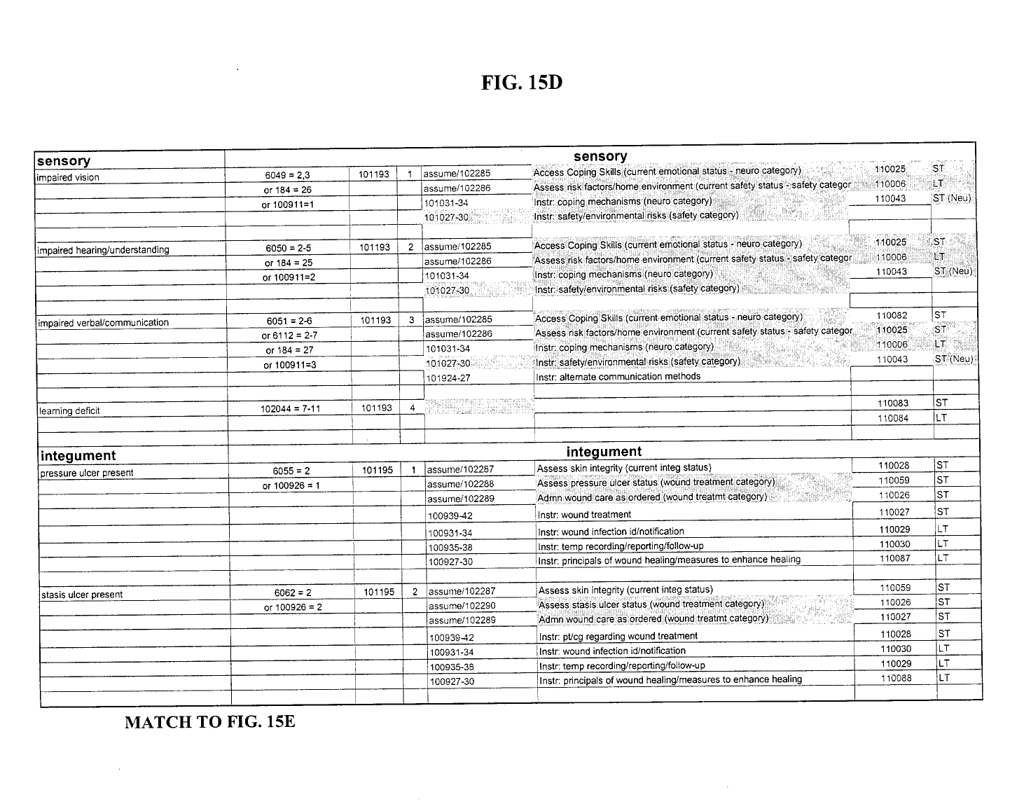

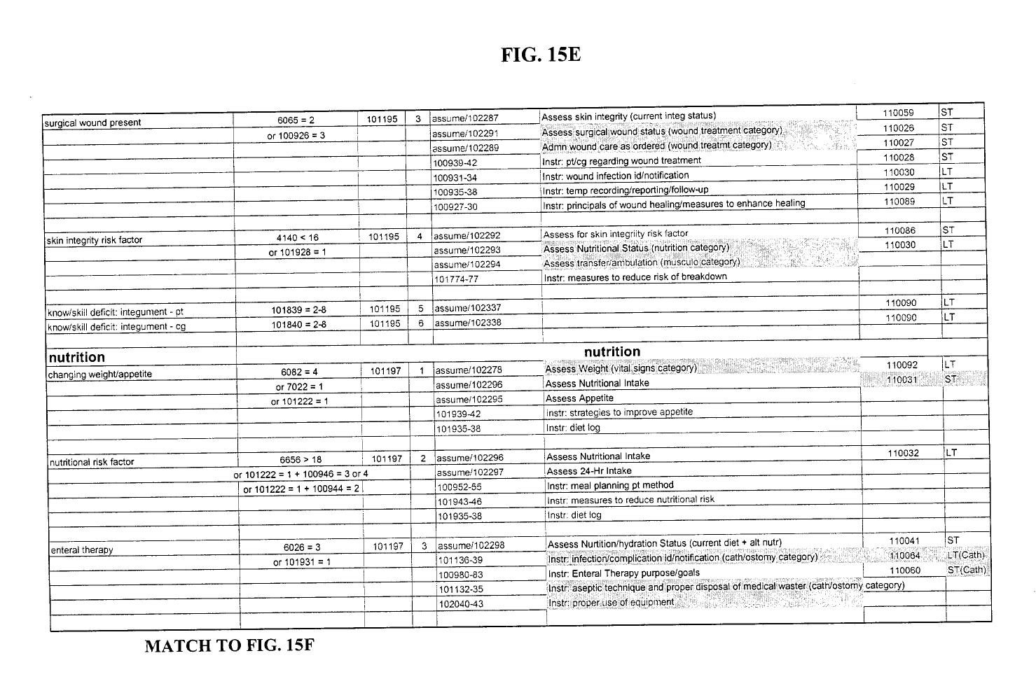

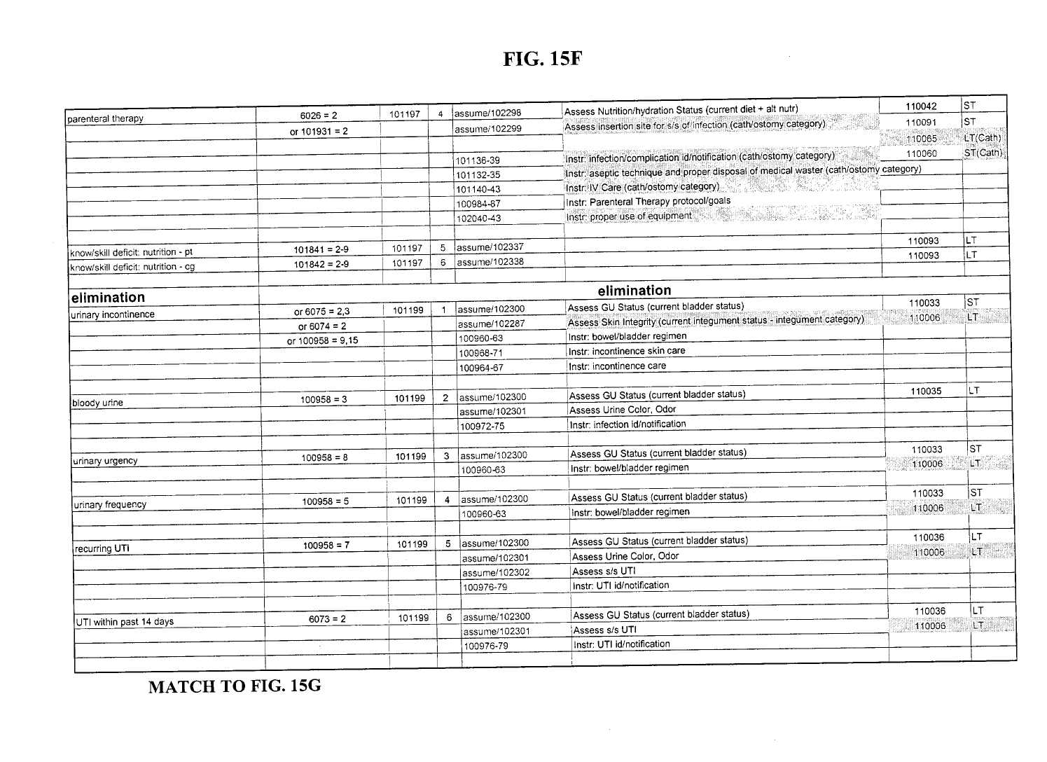

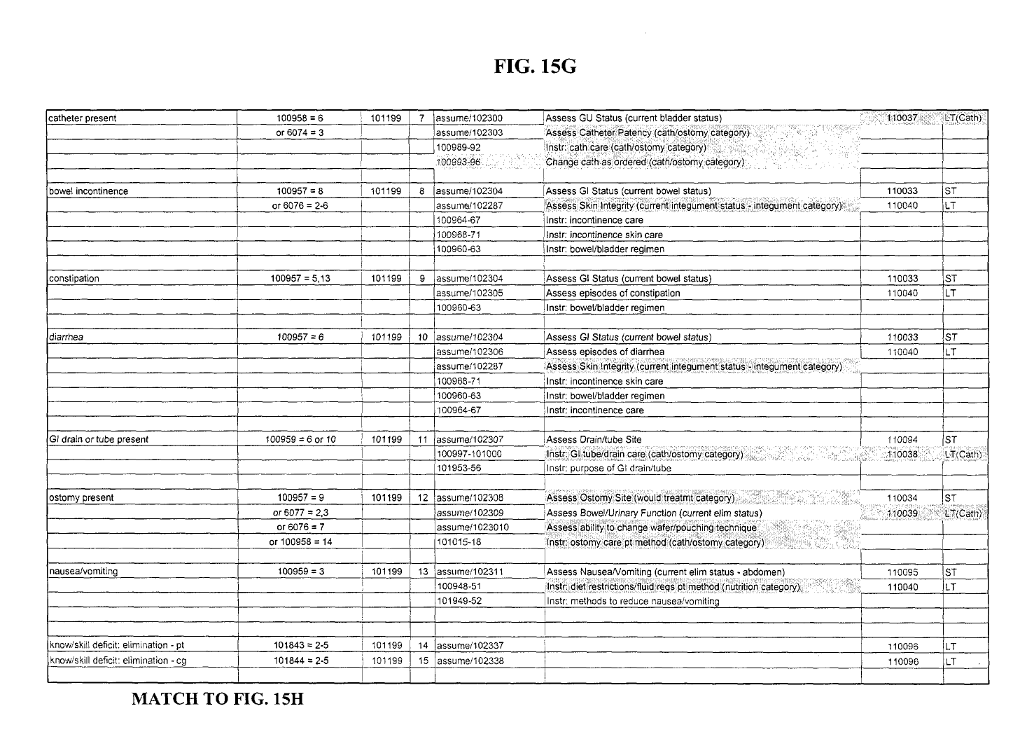

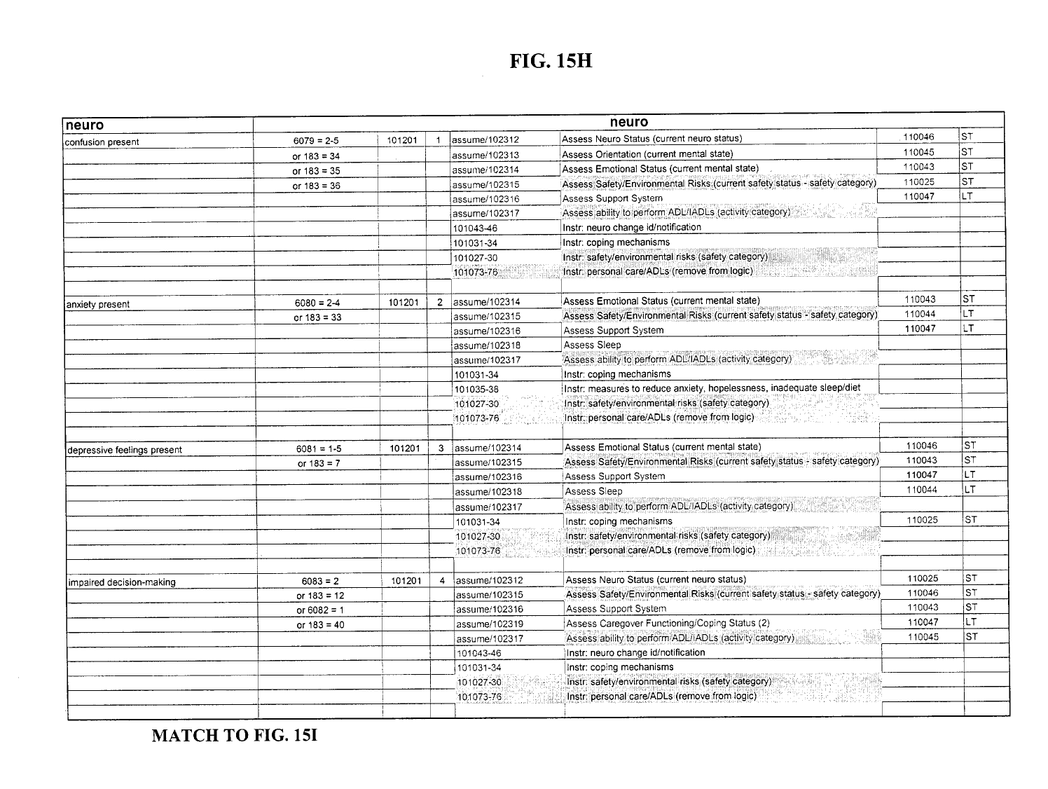

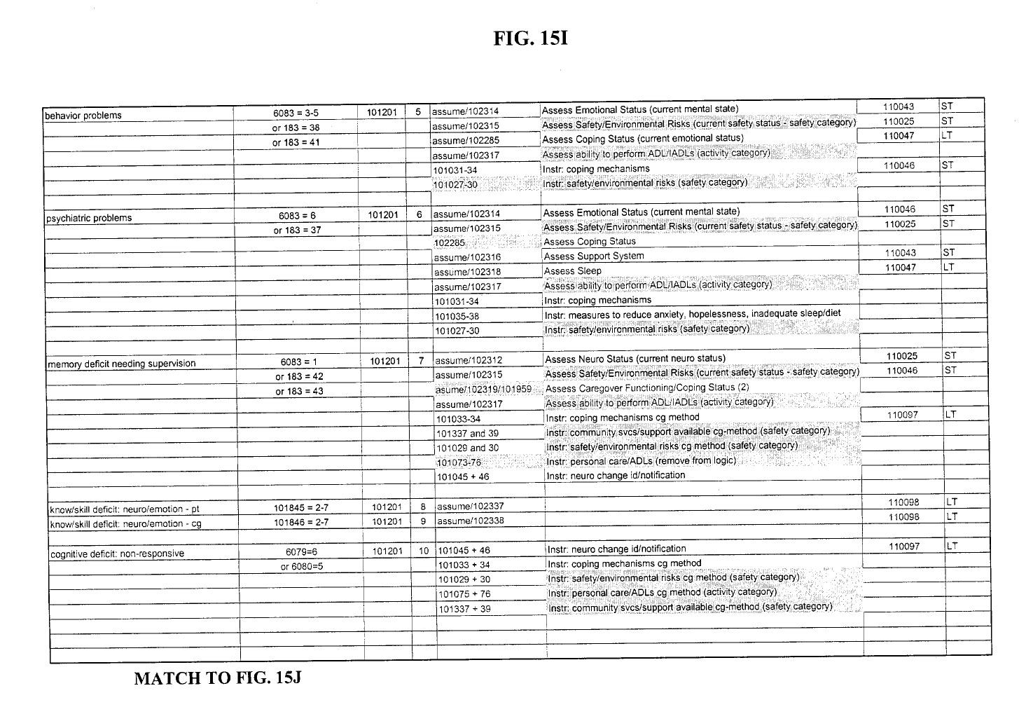

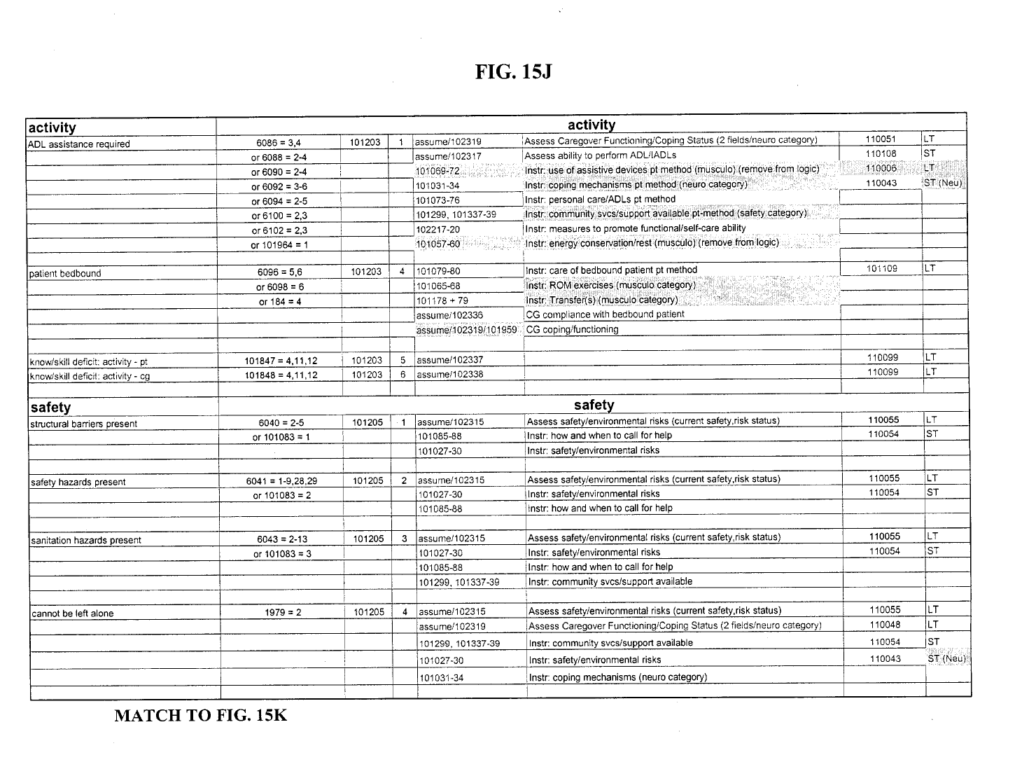

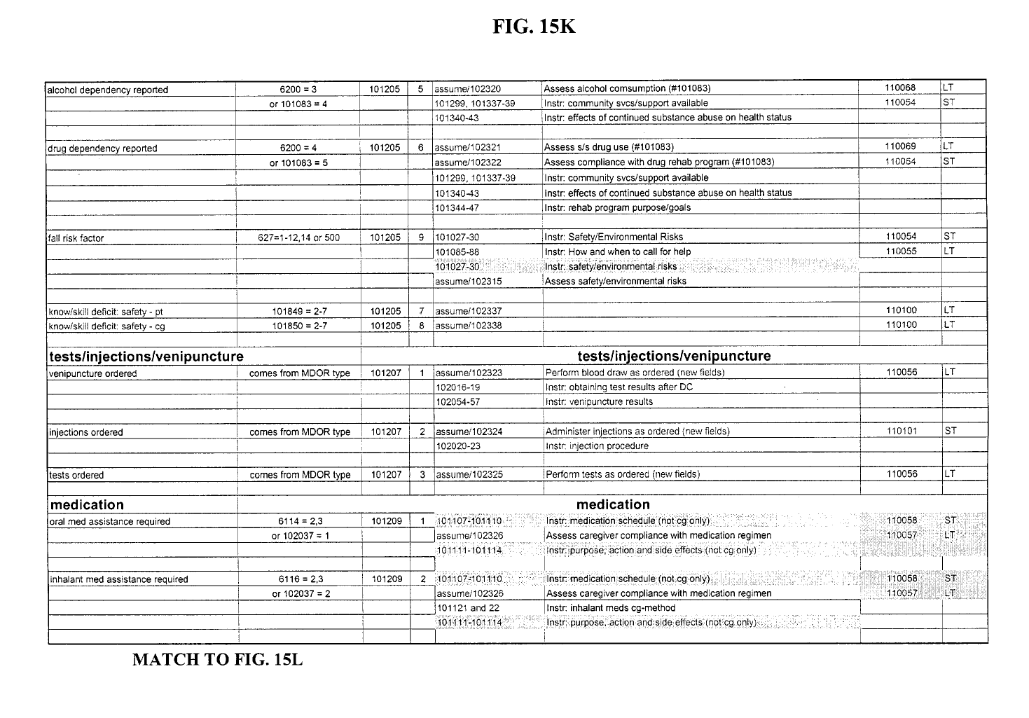

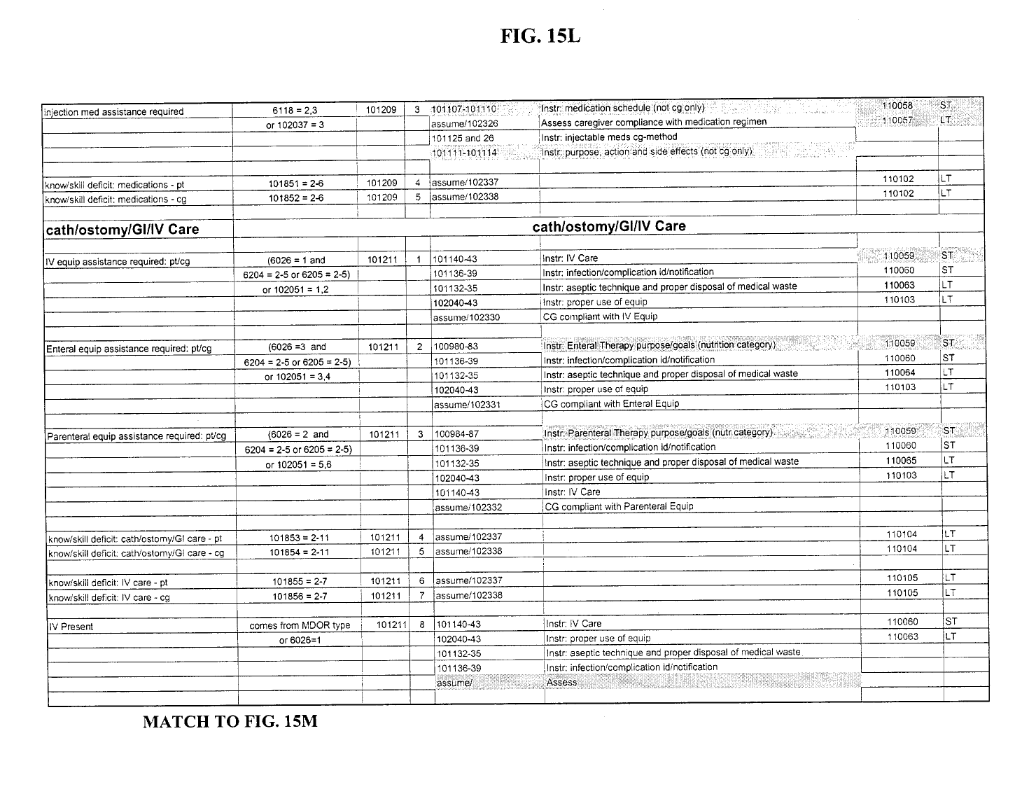

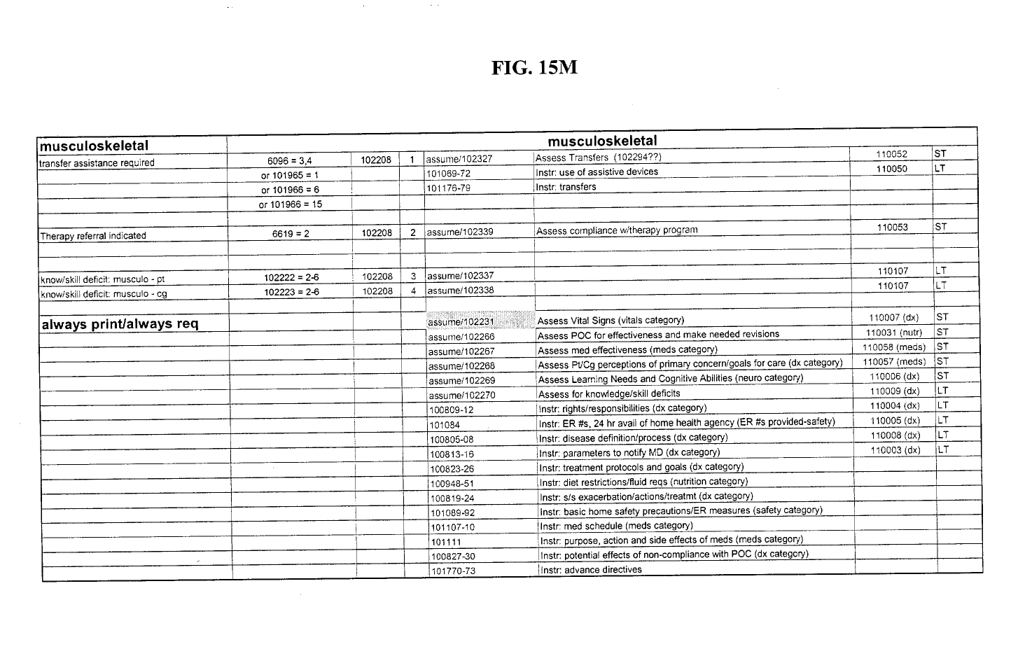

Second, NDoc analyzes the charting responses made by the clinician, and creates category-specific “problems”. FIG. 15 illustrates an example of actual “logic” or coding created in order to align a wide variety of problems with one or more suggested treatments or “interventions.”

Third, once a problem is defined, the following things automatically take place: (1) the problem appears on a Patient PROBLEMS List 92 that can be viewed from any NDoc function; (2) page 2 of every charting category in NDoc's “Today's Care” function displays the defined problem 94; (3) all Outcomes 96 related to the problem become highlighted (in, for example, a particular color, such as red) and are required to be charted prior to the patient's discharge from the agency; (4) all hyperlinks 98 in the Navigation Frame 28 of NDoc's “Today's Care” function that contain the problem are highlighted; and (5) pre-defined 485 interventions or treatments 100 are highlighted and—along with short-term and long-term goals 102 relating to the problem—printed on the 485.

The following Example provides a more detailed examination of each of the problem-triggered results.

### VI. EXAMPLE

Step (a): The problem appears on a Patient PROBLEMS List 92 that can be viewed from any NDoc function.

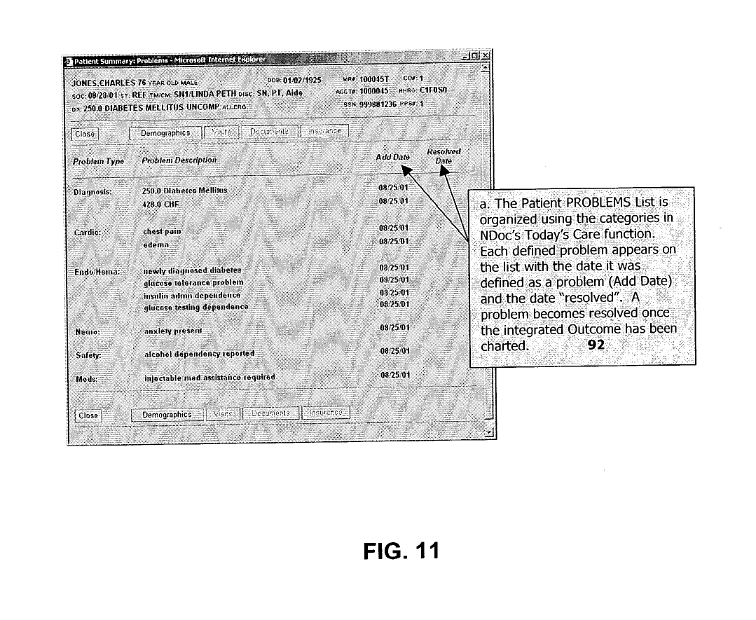

The Patient PROBLEMS List 92 is a list of all the problems defined for a patient. It is created based on analysis of the clinician's charting (both at the SOC visit and throughout the clinical episode) and is organized using the categories defined in NDoc's “Today's Care” function. The “Add Date” reflects the date the problem was defined and the “Resolved Date” reflects the date the integrated Outcome was charted. See FIG. 11.

Step (b): Page 2 of every charting category in NDoc's “Today's Care” function displays the defined problem 94.

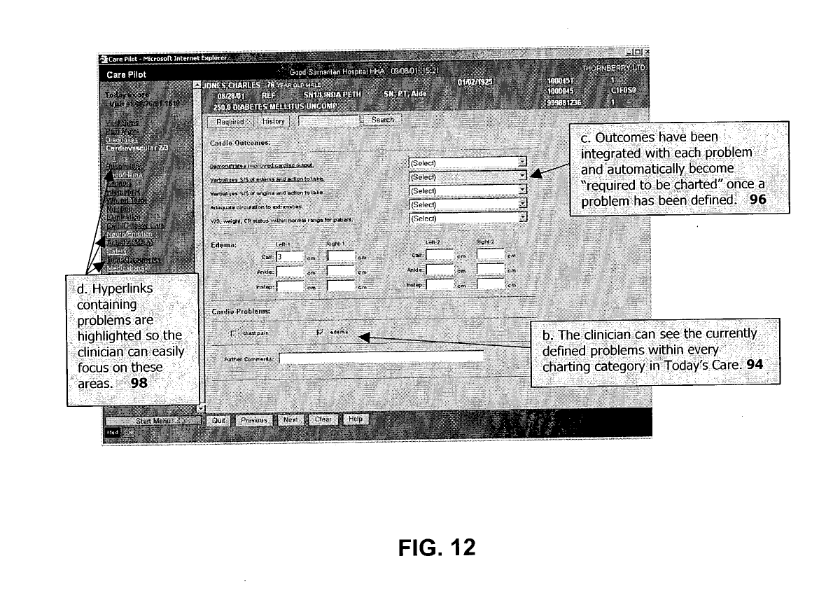

In this Example, as shown in FIGS. 11 and 12, edema has been identified as a problem. On page 2 of the Cardiovascular category in NDoc's “Today's Care” function, the “Cardio Problems” field has edema identified as a current problem by displaying the checkmark next to the edema entry.

Step (c): All Outcomes 96 related to the problem become highlighted (again, in a particular color, for example, such as red) and integrated with each problem; once a problem has been defined, it automatically becomes “required to be charted” prior to the patient's discharge from the agency.

As shown in FIG. 12, the Outcome that reads “Verbalizes S/S of edema and actions to take” has become highlighted. This outcome must not be charted immediately, but must be charted before the patient can be discharged from the agency.

Step (d): All hyperlinks in the Navigation Frame of NDoc's “Today's Care” function that contain the problem are highlighted.

The hyperlinks 98 in the Navigation Frame 28 allow the clinician to easily and immediately focus on the patient's defined problem areas.

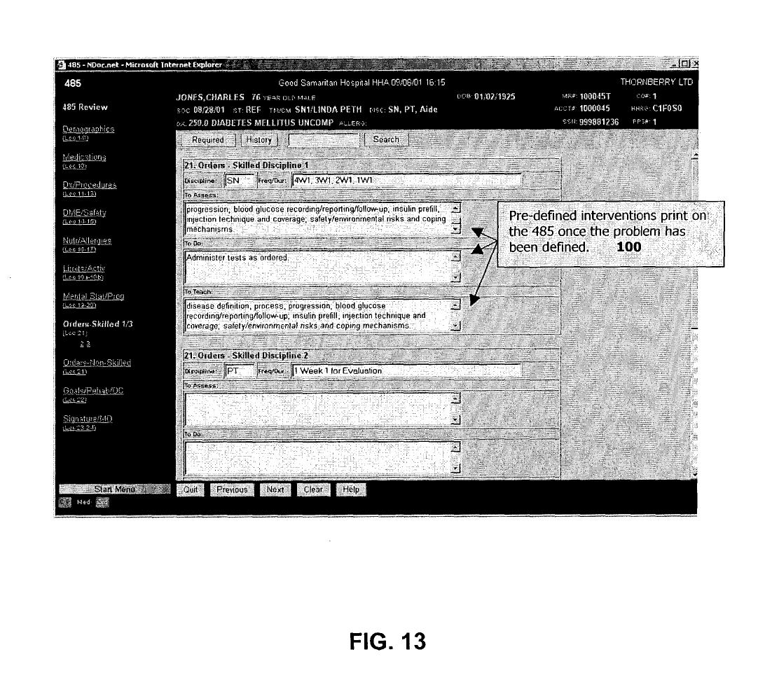

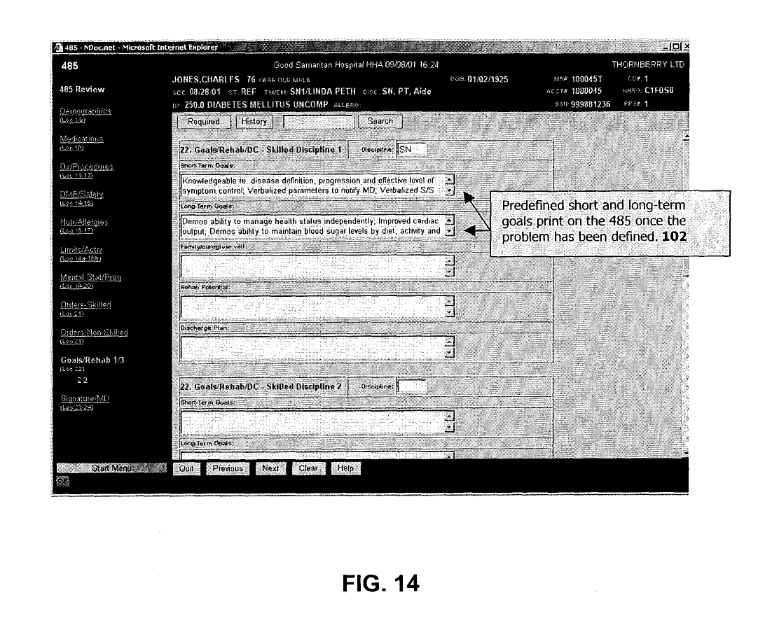

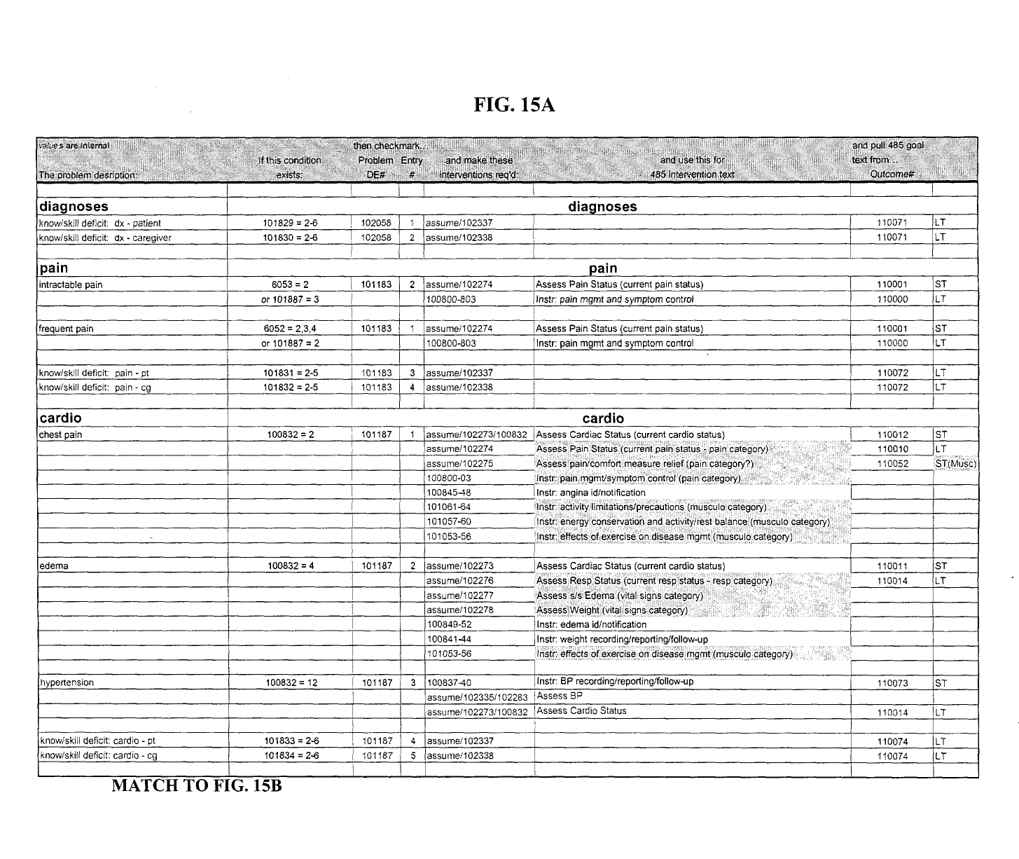

Step (e): Pre-defined 485 interventions 100, and short- and long-term goals 102 relating to the problem, print on the 485. See FIGS. 13 and 14.

One of the many benefits of the NDoc automated problem list is the automatic production of a 485 that contains language for the 485's Plan of Care section that directly reflects the content of the problem list. As such, the present invention eliminates the typical inconsistencies between the medical record and 485 which are quite often found in existing manual and automated systems. By not intervening, the clinician assures that the desired continuity (from record to 485) exists.

The result is a consistent patient record that ties together the OASIS documents, plan of care, 485 and visit charting. It is customized to the patient by simply charting the OASIS SOC Assessment, along with visit interventions under “Today's Care” charting categories during the clinical episode. The clinician is directed to the defined problem areas through the highlighted category hyperlinks and can view all currently defined problems when charting the associated outcomes on page 2 of each charting category within “Today's Care.”

A problem-related outcome can be charted as often as the clinician wishes, but must be charted prior to discharging the patient from the agency. Once an outcome is charted, the Patient PROBLEMS list displays a Resolved Date, and the checkmark identifier will no longer display under the “Problem” field on page 2 of the associated category.

The various six-digit codes shown throughout FIG. 15 represent data entry fields within NDoc. That is, each unique six-digit number corresponds with one, and only one, field within NDoc. For example, if a patient is identified as having edema, and then the charting clinician associates a value of “4” with a question in NDoc corresponding to Code 100832, several things are automatically triggered.

A checkmark will be placed in the field within NDoc that corresponds to Problem DE#101187, and specifically, in the second entry (Entry #2) within Problem DE#101187.

NDoc will also automatically indicate a number of different interventions which have been pre-defined to correspond to a patient diagnosed with edema and having a value of “4” for field 100832. Each of the distinct interventions has been assigned a code (in FIG. 15, for example, the list codes for the foregoing scenario are 102273, 102276, 102277, 102278, 100849-52, 100841-44 and 101053-56). It should be noted that a particular intervention could be applicable to more than one condition. For example, the intervention corresponding to code 102273 has also been associated with a patient diagnosed as having chest pain and a value of “2” for the field corresponding to code 100832.

Each individual intervention has also been pre-defined to have a corresponding description for use in connection with the 485 intervention text. For example, if the intervention corresponding to code 101053-56 is triggered, the 485 intervention text will be: “Instr: effects of exercise on disease mgmt (musculo category).”

Certain interventions have further associated with them pre-defined goals or Outcomes, each of which has been given its own unique code. The text for the 485 goal is then pulled from the particular Outcome previously defined.

VII. Removing Problems From the List

Once defined, problems cannot be removed from the list. Outcomes must be charted to “resolve” the problem. The only exception to this rule is if a problem defined in error is discovered while still charting the visit. As long as the user has not previously signed off the visit, the problem can be removed. After signing off the visit, the outcome must be charted with the selection of “error.”

VII. Reoccurring Problems

Once a problem has been defined and an outcome charted to resolve, the problem may reoccur. When this happens, the problem is simply charted again. This will “trigger” the same problem-defined results—including a second entry of the problem on the Patient PROBLEMS List with the newly defined date.

If not otherwise stated herein, it may be assumed that all components and/or processes described heretofore may, if appropriate, be considered to be interchangeable with similar components and/or processes disclosed elsewhere in the specification, unless an express indication is made to the contrary.

It should be appreciated that the systems and methods of the present invention may be configured and conducted as appropriate for any context at hand. The embodiments described above are to be considered in all respects only as illustrative and not restrictive. All changes which come within the meaning and range of equivalency of the claims are to be embraced within their scope.

What is claimed is:

1. A point-of-care clinical documentation system for use in the field of home healthcare, comprising:
means for storing medical conditions and one or more pre-defined treatments corresponding to each of said medical conditions;
recording means for an individual to record a physiological or psychological assessment of a patient;
a processor for associating said assessment to at least one of said medical conditions and generating the one or more pre-defined treatments that correspond to said condition; and
a display for displaying the automatically generated pre-defined treatments.

2. The system of claim 1, wherein said processor automatically associates said assessment with one or more of said medical conditions without said individual being required to actively make such association.

3. The system of claim 1, wherein said generation of said one or more pre-defined treatments occurs automatically, without intervention from said individual.

4. The system of claim 3, wherein said automatic generation is achieved by matching a first pre-assigned code given to said medical condition with a second pre-assigned code given to each of said one or more pre-defined treatments.

5. A method of facilitating the point-of-care treatment of a home healthcare patient, the method implementing rules-based logic on a computer system, comprising:
storing medical conditions and one or more pre-defined treatments corresponding to each of said medical conditions;
recording a physiological or psychological assessment of a patient;
associating said assessment to at least one of said medical conditions and generating the one or more pre-defined treatments that correspond to said condition; and
displaying the automatically generated pre-defined treatments.

6. The method of claim 5, wherein said step of recording is performed by an individual, following which said step of associating said assessment with one or more of said medical conditions occurs automatically, without said individual being required to actively make such association.

7. The method of claim 5, wherein said step of recording is performed by an individual, and said step of generating said one or more pre-defined treatments occurs automatically, without intervention from said individual.

8. The method of claim 7, wherein said automatic generation step is achieved by matching a first pre-assigned code given to said medical condition with a second pre-assigned code given to each of said one or more pre-defined treatments.

9. A system for simultaneously running multiple interactive browser sessions, comprising:
means for providing a single log-in procedure;
means for invoking a menuing session;
wherein said means for invoking a menuing session allows access to any of multiple functionally-organized sub-applications, each sub-application pertaining to a section of a first patient electronic medical record having several processes associated therewith and running it in its own persistent, full-screen browser window, enabling a user of said system to concurrently perform several disparate tasks without having to complete and close one process before starting another.

10. The system of claim 10, wherein said means for invoking a menuing session further provides read-only access to a second patient medical record without closing any of said processes open to said first electronic medical record.
